(19) United States
(12) Patent Application Publication
(10) Pub. No.: US 2006/0154765 A1
(43) Pub. Date: Jul. 13, 2006

(54) Transmission device for an agitator of impression material

(76) Inventor: Wen-Hao Wang, Taipei City (TW)

Correspondence Address: BIRCH STEWART KOLASCH & BIRCH, PO BOX 747, FALLS CHURCH, VA, 22040-0747, US

(21) Appl. No.: 11/031,063

(22) Filed: Jan. 10, 2005

(51) Int. Cl. F16H 7/00

(52) U.S. Cl. 474/148; 474/89; 474/86

(57) ABSTRACT

The present invention discloses a transmission device for agitator of impression material, wherein belt pulleys are installed on the V-frame of the agitator of impression material and the fixing pole of a motor; complementary rollers are also installed on the V-frame, and belts wrap over those belt pulleys, those complementary rollers, and an annular trench on the perimeter of the containing cup. When the containing basin on the V-frame is driven to rotate by the motor of the agitator of impression material, the containing cup is driven to rotate opposite the rotating direction of the containing basin via the interlinked actuation of the aforementioned belts, belt pulleys, and complementary rollers, so that the impression material can be evenly mixed by the high-speed rotation and can be densified by the centrifugal force and the air bulbs inside the impression material can be eliminated.

### FIELD OF THE INVENTION

The present invention relates to a transmission device, particularly to a transmission device for the agitator of the impression material, which enables the agitated impression material to be of high density and no air bulb via a high-speed rotation.

### BACKGROUND OF THE INVENTION

In regard to that the dental impression material is agitated manually in tradition and there is no specifically designed agitator thereof, the inventor proposed an invention of an agitator for impression material (Taiwan, R.O.C. Patent Publication No. 274741), which discloses a transmission device that provides a planetary gear transmission system to enable the impression material to revolve around the sun gear and be agitated by rotation so that the impression material can be evenly mixed by high speed rotation and be densified by centrifugal force with the air being bulb eliminated. Owing to the creative enthusiasm of the inventor and to diversify the transmission device for the agitator of impression material, a utilitarian transmission device for the agitator of impression material is further proposed herein.

### SUMMARY OF THE INVENTION

The objective of the present invention is to provide a transmission device for the agitator of impression material, wherein the transmission device adopts the driving means of belt pulleys in cooperation with belts to enable the agitated impression material to be of high density, superior elasticity, and no air bulb so that the product quality can be promoted.

To achieve the aforementioned objective, in the transmission device for the agitator of impression material of the present invention, the agitator at least comprises: a motor, a V-frame, a containing basin, and a containing cup, wherein the V-frame is installed on the rotating shaft of the motor, and the containing basin is installed on the V-frame, and the containing cup is disposed on one side of the V-frame with its mouth positioned inside the opening of the containing basin. The transmission device primarily comprises: a first belt pulley, a second belt pulley, a first belt, and a second belt. The first belt pulley is installed on a fixing pole of the motor and disposed in the interior of the containing basin. The second belt pulley is installed on the V-frame and disposed in a position corresponding to the containing cup. The aforementioned complementary rollers are installed on the V-frame, and the axis of the pair of complementary rollers is perpendicular to the axes of those belt pulleys. The first belt wraps over the first belt pulley and the second belt pulley, and the second belt wraps over the second belt pulley, the pair of complementary rollers, and an annular trench on the perimeter of the containing cup.

In summary, in the transmission device for the agitator of impression material provided by the present invention, an appropriate number of belt pulleys are installed on the V-frame of the agitator of impression material and the fixing pole of the motor, and an appropriate number of complementary rollers are also installed on the V-frame, and an appropriate number of belts wrap over those belt pulleys, those complementary rollers, and the annular trench on the perimeter of the containing cup. When the containing basin on the V-frame is driven to rotate by the motor of the agitator of impression material, the containing cup is driven to rotate opposite the rotating direction of the containing basin via the interlinked actuation of the aforementioned belts, belt pulleys, and complementary rollers, so that the impression material can be evenly mixed by the high-speed rotation and can be densified by the centrifugal force and the air bulbs inside the impression material can be eliminated.

### BRIEF DESCRIPTION OF THE DRAWINGS

FIG. 1 is a sectional view of the agitator of impression material of the present invention.

FIG. 2 is a structural schematic diagram of the transmission device of the present invention.

FIG. 3 is an operational schematic diagram of the transmission device of the present invention.

FIG. 4A and FIG. 4B are diagrams showing the states before and after the modification of the belts' tension in the transmission device of the present invention.

### DETAILED DESCRIPTION OF THE PREFERRED EMBODIMENTS

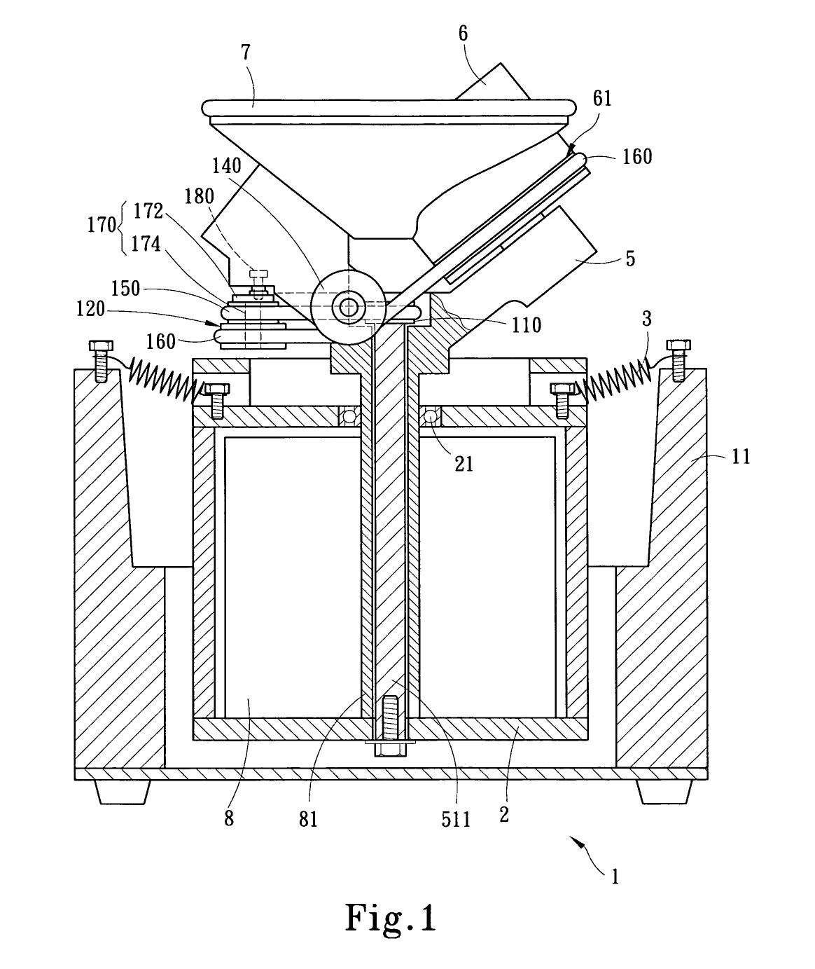

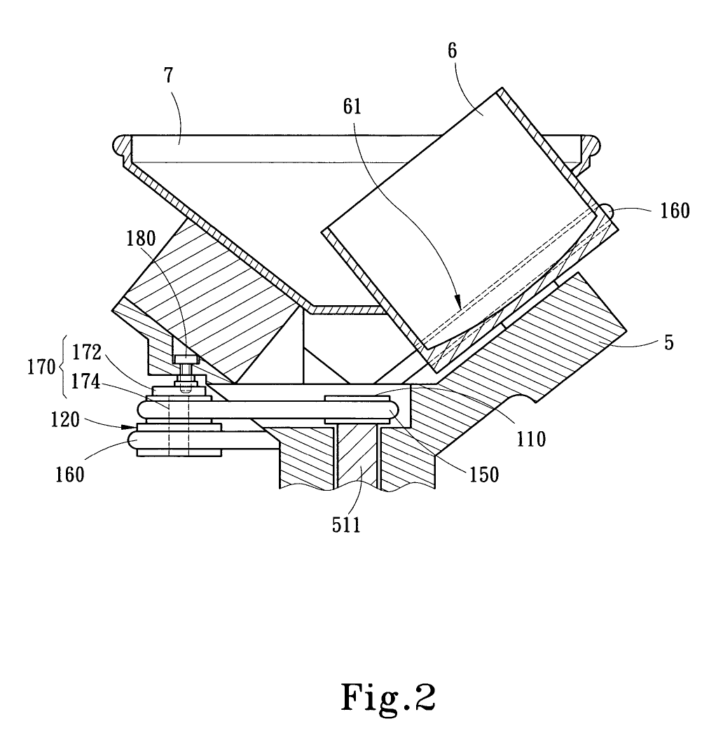

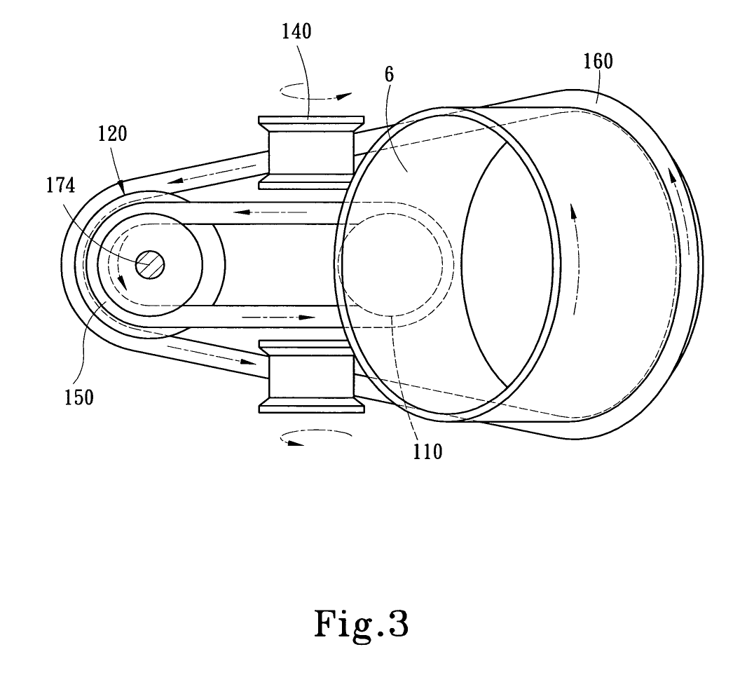

Referring to FIG. 1, a sectional view of the agitator of impression material of the present invention, a square seat 1 is utilized to support the whole structure; a cylindrical motor-disposing seat 2 is installed in the cylindrical space occupying the central portion of the seat 1. Four support masts 11 vertically project upward separately from four corners of the seat 1 to suspend the motor-disposing seat 2 and all the components disposed above the motor-disposing seat 2 in the central space of the seat 1 via stretch springs 3 spanning between the top of the support mast 11 and the perimeter of the motor-disposing seat 2 so that the vibration coming from the suspended components can be damped and the operation of the agitator can be secured. The damping design works just like the centrifugal dehydrator of the laundry machine, and as the present invention adopts a high-speed eccentric rotation to perform the agitation, the damping design can improve the stability of operation. A motor 8 is installed inside the motor-disposing seat 2, and a V-frame 5, which is driven to rotate synchronically by the motor 8, is installed above the motor-disposing seat 2; a cone-shaped containing basin 7 and a transmission device are installed above the V-frame 5 (detailed reference numerals of the drawing are shown in FIG. 2 and FIG. 3). A containing cup 6, which contains the impression material and performs the agitation, is installed above one side of the V-frame 5; the cylindrical containing cup 6 obliquely penetrates the aforementioned containing basin 7; the mouth of the containing cup 6 is inside the containing basin 7 and obliquely upward. When the agitator is started, the containing cup 6 is driven to rotate opposite the rotating direction of the containing basin 7 via the interlinked actuation of the transmission device; this kind of rotation design is to enable the impression material to be completely agitated and evenly mixed. The centrifugal force of high-speed rotation will throw the impression material outward, and the tilt design of the containing cup 6 can block the out-throw of the impression material lest the impression material be thrown out of the containing basin 7. The impression material is out-thrown and gathered to the rim, and the air bulbs inside the impression material will be expelled out, and further, the axial rotation of the containing cup 6 will constantly move the impression material away from the rim lest the impression material should long stay over there. This agitation way has not only the advantage of even mixing but also the effect of densification and non-air bulb, and as the high-speed rotatary agitation needs only very short time, the user has plenty time to undertake the other molding processes.

Referring to FIG. 1 to FIG. 3 for detailed structures of the aforementioned components and transmission device, a motor 8 is tightly installed inside the motor-disposing seat 2; a rotating shaft 81 of the motor 8 is hollow and installed to project upward to penetrate the top of the motor-disposing seat 2, and a shaft bearing 21, positioned in the interface where the rotating shaft 81 penetrates the motor-disposing seat 2, is used to fix the rotating shaft 81 of the motor 8. The V-frame 5 is fixedly installed at the outthrust top end of the rotating shaft 81 of the motor 8, and the V-frame 5 can be driven to rotate synchronically by the motor 8.

The transmission device primarily comprises: a first belt pulley 110, a second belt pulley 120, a pair of complementary rollers 140, a first belt 150, and a second belt 160. The first belt pulley 110 is shafted with a fixing pole 511 of the motor 8 and disposed inside the V-frame 5, and the first belt 150 wraps over an annular trench on the perimeter of the first belt pulley 110, and the aforementioned fixing pole 511 is disposed inside the rotating shaft 81 of the motor 8. The second belt pulley 120 is installed on the V-frame 5 and disposed in the position corresponding to the containing cup 6, and the first belt 150 and the second belt 160 separately wrap over two annular trenches on the perimeter of the second belt pulley 120. The complementary rollers 140 are also installed on the V-frame 5, and in the present embodiment, two complementary rollers 140 are disposed symmetrically, and the axis of the complementary rollers 140 is perpendicular to the axes of the first belt pulley 110 and the second belt pulley 120. The first belt 150 wraps over the first belt pulley 110 and the second belt pulley 120, and the second belt 160 wraps over the second belt pulley 120, two complementary rollers 140 and an annular trench 61 on the perimeter of the containing cup 6. In the present embodiment, the first belt pulley 110, the second belt pulley 120 and two complementary rollers 140 are all driven wheels and without driving ability, and the first belt 150 or the second belt 160 can be a cog belt or a V-belt. Further, for the convenience of the second belt 120's wrapping, the perimeter of the complementary roller 140 can be design to be inward concaved.

Referring again to FIG. 1 to FIG. 3, when the motor 8 drives the containing basin 7 on the V-frame 5 to rotate clockwise, the containing cup 6 will be driven to rotate counterclockwise via the interlinked actuation of the first belt pulley 110, the second belt pulley 120, two complementary rollers 140, the first belt 150, and the second belt 160 so that the impression material can be evenly mixed by the high-speed rotation and can be densified by the centrifugal force, and the air bulbs can be eliminated.

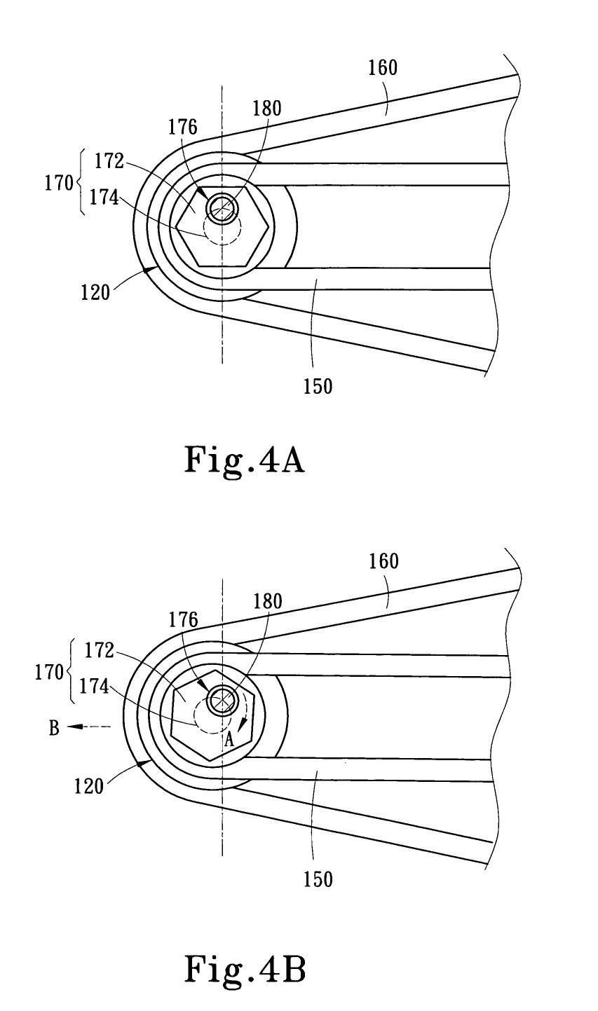

Please refer to FIG. 2, FIG. 4A, and FIG. 4B. After repeated utilization, the belt will become loose gradually. In addition to changing the belt, the present invention provides an alternative design. In the present embodiment, the second belt pulley 120 is equipped with a connecting member 170, which comprises a plate-like head portion 172 (in the present embodiment, it's a hexagonal plate) and a rod-like tail portion 174, wherein the head portion 172 is engaged to the V-frame 5 via the securing function of a screw 180 and an eccentric screw hole 176 on the plate-like head portion 172 and the tail portion 174 functions as the rotating axis of the second belt pulley 120. When the first belt 150 and the second belt 160 become loose, firstly the screw 180 is loosened, and then the head portion 172 is rotated along the direction indicated by the arrow A in FIG. 4B with the screw 180 being the axis, and owing to the eccentricity of the screw hole 176, the second belt pulley 120 will be moved along the direction indicated by the arrow B, and then the relative position of the first belt pulley 110 and the second belt pulley 120 is changed; thus the tension of the first belt 150 or the second belt 160 can be modified, and after modification, the screw 180 is screwed tightly again.

What is claimed is:

1. A transmission device for an agitator of impression material, which at least comprises: a motor, a V-frame, a containing basin, and a containing cup, wherein said V-frame is installed on a rotating shaft of said motor, and said containing basin is installed on said V-frame, and said containing cup is disposed on one side of said V-frame with its mouth positioned inside the opening of said containing basin, and wherein said transmission device comprises:
a first belt pulley, installed on a fixing pole of said motor and disposed in the interior of said containing basin;
a second belt pulley, installed on said V-frame and disposed in a position corresponding to said containing cup;
a pair of complementary rollers, installed on the V-frame, with the axis of said pair of complementary rollers perpendicular to the axes of said belt pulleys;
a first belt, wrapping over said first belt pulley and said second belt pulley; and
a second belt, wrapping over said second belt pulley, said pair of complementary rollers, and an annular trench on the perimeter of said containing cup.

2. The transmission device for the agitator of impression material according to claim 1, which is characterized in that each of said first belt and said second belt is a cog belt.

3. The transmission device for the agitator of impression material according to claim 1, which is characterized in that each of said first belt and said second belt is a V-belt.

4. The transmission device for the agitator of impression material according to claim 1, which is characterized in that each of said first belt pulley, said second belt pulley and said pair of complementary rollers is a driven wheel and without driving ability.

5. The transmission device for agitator of impression material according to claim 1, which is characterized in that the perimeters of said pair of complementary rollers are inward concaved for the convenience of said second belt wrapping.

6. The transmission device for agitator of impression material according to claim 1, which is characterized in that said second belt pulley is equipped with a connecting member, which comprises a plate-like head portion and a rod-like tail portion, and said plate-like head portion has an eccentric screw hole on the plate-like head portion, which cooperates with a screw to secure said head portion to said V-frame, and the relative position of said first belt pulley and said second belt pulley can be modified via rotating said head portion of said connecting member, and thereby, the tension of said belts can be adjusted.
